(19) United States
(12) Patent Application Publication
(10) Pub. No.: US 2022/0185337 A1
(43) Pub. Date: Jun. 16, 2022

(54) SYSTEMS AND METHODS FOR DRIVING MODE SWITCHING IN AUTONOMOUS DRIVING

(71) Applicant: BEIJING VOYAGER TECHNOLOGY CO., LTD., Beijing (CN)

(72) Inventors: Tingyou MING, Hangzhou (CN); Xiaowei CHEN, Beijing (CN); Xiaofeng HUANG, Beijing (CN); Jiangyuan SUN, Beijing (CN); Wenchang WU, Mountain View, CA (US); Xiaocheng ZHANG, Mountain View, CA (US)

(73) Assignee: BEIJING VOYAGER TECHNOLOGY CO., LTD., Beijing (CN)

(21) Appl. No.: 17/653,293

(22) Filed: Mar. 3, 2022

Related U.S. Application Data
(63) Continuation of application No. PCT/CN2019/104176, filed on Sep. 3, 2019.

(51) Int. Cl. B60W 60/00; B60W 30/182; B60W 50/08; B60W 50/02

(52) U.S. Cl. CPC B60W 60/0057; B60W 30/182; B60W 2540/215; B60W 50/0205; B60W 50/0225; B60W 50/082

(57) ABSTRACT

The present disclosure provides a system and method for driving mode switching in autonomous driving. The method may include obtaining status information of a vehicle system, the status information including a current driving mode of the vehicle system; obtaining at least one mode switching condition, each of the at least one mode switching condition corresponding to a candidate driving mode that triggers switching the vehicle system from the current driving mode to the candidate driving mode; determining that the status information of the vehicle system satisfies one of the at least one mode switching condition; designating a candidate driving mode corresponding to the one of the at least one mode switching condition as a target driving mode; switching the current driving mode into the target driving mode.

### CROSS-REFERENCE TO RELATED APPLICATIONS

This application is a continuation of International Application No. PCT/CN2019/104176, filed on Sep. 3, 2019, the contents of which are hereby incorporated by reference.

### TECHNICAL FIELD

The present disclosure generally relates to systems and methods for autonomous driving, and in particular, to systems and methods for driving mode switching in autonomous driving.

### BACKGROUND

With the development of micro-electronic and robotic technologies, the exploration of autonomous driving has developed rapidly. Autonomous vehicles may replace human drivers with computer-implemented intelligence to control and/or drive the vehicle. Typically, autonomous vehicles utilize a number of sensors and other automation technology to help navigate the surrounding environment. However, before the completion of the Level 4 and above unmanned systems, human still remains an important part of the entire unmanned system. Thus, autonomous vehicles may be operable in both an autonomous driving mode (e.g., vehicle inputs being provided by one or more processors) and a manual-driving mode (e.g., vehicle inputs being provided by a person). Both a processor and a user may be allowed to change a driving mode of an autonomous driving vehicle. Therefore, it may be desirable to provide a method or system to allow a safe transition between an autonomous driving mode and a manual-driving mode.

### SUMMARY

In a first aspect of the present disclosure, a system for driving mode switching in autonomous driving is provided. The system may include at least one storage medium including a set of instructions, and at least one processor in communication with the at least one storage medium. When executing the set of instructions, the at least one processor may be configured to direct the system to: obtain status information of a vehicle system, the status information including a current driving mode of the vehicle system; obtain at least one mode switching condition, each of the at least one mode switching condition corresponding to a candidate driving mode that triggers switching the vehicle system from the current driving mode to the candidate driving mode; determine that the status information of the vehicle system satisfies one of the at least one mode switching condition; designate a candidate driving mode corresponding to the one of the at least one mode switching condition as a target driving mode; switch the current driving mode into the target driving mode. The current driving mode and the at least one candidate driving mode may include a manual-driving mode, an autonomous driving mode, and a safe mode. The autonomous driving mode may include at least two sub-modes.

In some embodiments, the at least two sub-modes of the autonomous driving mode may include a full-function sub-mode, a standby sub-mode, and a degrade sub-mode.

In some embodiments, the at least one mode switching condition may include a first mode switching condition that triggers switching the vehicle system from a full-function sub-mode to a standby sub-mode. The first mode switching condition may include receipt of an instruction for manual operation.

In some embodiments, the at least one mode switching condition may include a second mode switching condition that triggers switching the vehicle system from a standby sub-mode to a full-function sub-mode. The second mode switching condition may be that no manual operation is detected within a time period.

In some embodiments, the at least one mode switching condition may include a third mode switching condition that triggers switching the vehicle system from a full-function sub-mode or a standby sub-mode to a degrade sub-mode. The third mode switching condition may be that the vehicle system has a correctable failure.

In some embodiments, the at least one mode switching condition may include a fourth mode switching condition that triggers switching the vehicle system from a degrade sub-mode to a full-function sub-mode or a standby sub-mode. The fourth mode switching condition may be that the correctable failure is resolved.

In some embodiments, the manual-driving mode may further include a starting sub-mode and a ready sub-mode.

In some embodiments, the vehicle system may include a vehicle platform and an autonomous platform. The at least one mode switching condition may include a fifth mode switching condition that trigger switching the vehicle system from the starting sub-mode to a ready sub-mode. The fifth mode switching condition may be that failure is detected neither in the vehicle platform nor in the autonomous platform.

In some embodiments, the at least one processor may further be configured to direct the system to perform additional operations including: obtaining, from a user, an instruction for switching the vehicle system from the current driving mode to the target driving mode; determining that the status information of the vehicle system satisfies a mode switching condition corresponding to the target driving mode; switching the current driving mode to the target driving mode.

In some embodiments, the instruction may include at least one of operating a braking pedal of the vehicle system, operating a steering wheel of the vehicle system, pressing a mode switching button, or an oral or text instruction.

In a second aspect of the present disclosure, a method for driving mode switching in autonomous driving is provided. The method may be implemented on a computing device having at least one processor and a non-transitory storage medium. The method may include: obtaining status information of a vehicle system, the status information including a current driving mode of the vehicle system; obtaining at least one mode switching condition, each of the at least one mode switching condition corresponding to a candidate driving mode that triggers switching the vehicle system from the current driving mode to the candidate driving mode; determining that the status information of the vehicle system satisfies one of the at least one mode switching condition; designating a candidate driving mode corresponding to the one of the at least one mode switching condition as a target driving mode; switching the current driving mode into the target driving mode. The current driving mode and the at least one candidate driving mode may include a manual-driving mode, an autonomous driving mode, and a safe mode. The autonomous driving mode may include at least two sub-modes.

In a third aspect of the present disclosure, a non-transitory computer readable medium may store instructions, the instructions, when executed by at least one processor, the at least one processor may be configured to perform one or more of the following operations. Status information of a vehicle system may be obtained, and the status information may include a current driving mode of the vehicle system. At least one mode switching condition may be obtained, and each of the at least one mode switching condition may correspond to a candidate driving mode that triggers switching the vehicle system from the current driving mode to the candidate driving mode. The current driving mode and the at least one candidate driving mode may include a manual-driving mode, an autonomous driving mode, and a safe mode. The autonomous driving mode may include at least two sub-modes. That the status information of the vehicle system satisfies one of the at least one mode switching condition may be determined. A candidate driving mode corresponding to the one of the at least one mode switching condition may be designated as a target driving mode. The current driving mode may be switched into the target driving mode.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A is a schematic diagram illustrating an exemplary vehicle system according to some embodiments of the present disclosure;

FIG. 1B is a schematic diagram illustrating an exemplary vehicle with an autonomous driving capability according to some embodiments of the present disclosure;

FIG. 2A is a block diagram illustrating an exemplary manual-driving mode according to some embodiments of the present disclosure;

FIG. 2B is a block diagram illustrating an exemplary autonomous driving mode according to some embodiments of the present disclosure;

FIG. 3 is a schematic diagram illustrating exemplary hardware and/or software components of an exemplary computing device according to some embodiments of the present disclosure;

FIG. 4 is a block diagram illustrating an exemplary processing device according to some embodiments of the present disclosure;

FIG. 5 is a flowchart illustrating an exemplary process for driving mode switching according to some embodiments of the present disclosure; and

FIG. 6 is a schematic diagram illustrating an exemplary process for driving mode switching according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawings, all of which form part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Moreover, while the systems and methods disclosed in the present disclosure are described primarily regarding a ground transportation system, it should be understood that this is only one exemplary embodiment. The systems and methods of the present disclosure may be applied to any other kind of transportation system. For example, the systems and methods of the present disclosure may be applied to transportation systems of different environments including ocean, aerospace, or the like, or any combination thereof. The vehicle of the transportation systems may include a car, a bus, a train, a subway, a vessel, an aircraft, a spaceship, a hot-air balloon, or the like, or any combination thereof.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to systems and methods for driving mode switching among several driving modes, e.g., a manual-driving mode, an autonomous driving mode, a safe mode, in an autonomous vehicle. A driving mode may further include multiple sub-modes. For instance, the manual-driving mode may include a starting sub-mode and a ready sub-mode; the autonomous driving mode may include a full-function sub-mode, a standby sub-mode, and a degrade sub-mode. According to some systems and methods of the present disclosure, a processor may obtain status information of a vehicle system, obtain at least one mode switching condition, determine that the status information of the vehicle system satisfies one of the at least one mode switching condition, and designate a candidate driving mode corresponding to the one of the at least one mode switching condition as a target driving mode, where each of the at least one mode switching condition corresponding to a candidate driving mode that triggers switching the vehicle system from the current driving mode to the candidate driving mode. Furthermore, according to some systems and methods of the present disclosure, the processor may further switch the current driving mode into the target driving mode, which may improve safety and user experience during driving mode switching for a vehicle with an autonomous capability.

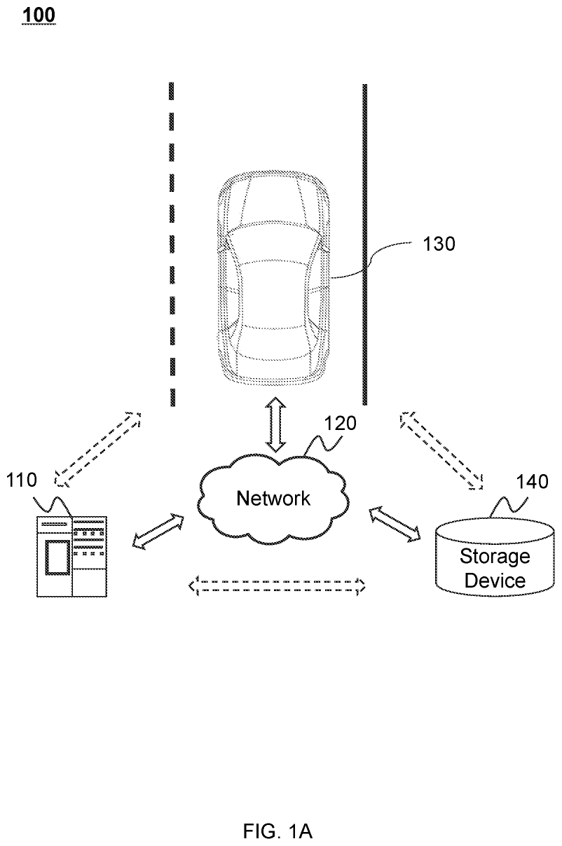

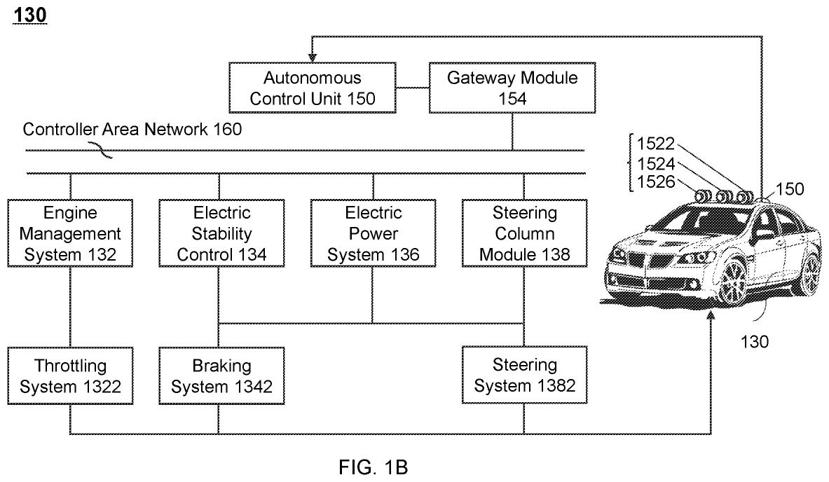

FIG. 1A is a schematic diagram illustrating an exemplary vehicle system according to some embodiments of the present disclosure. In some embodiments, the vehicle system 100 may include a processing device 110, a network 120, a vehicle 130, and a storage device 140. In some embodiments, the processing device 110 and/or the storage device 140 may be installed on the vehicle 130 as indicated by the bidirectional dotted arrows in FIG. 1A. In some embodiments, the vehicle 130 may include a processing engine and/or a storage on board, and also be connected to a processing device and/or a storage device via the network 120.

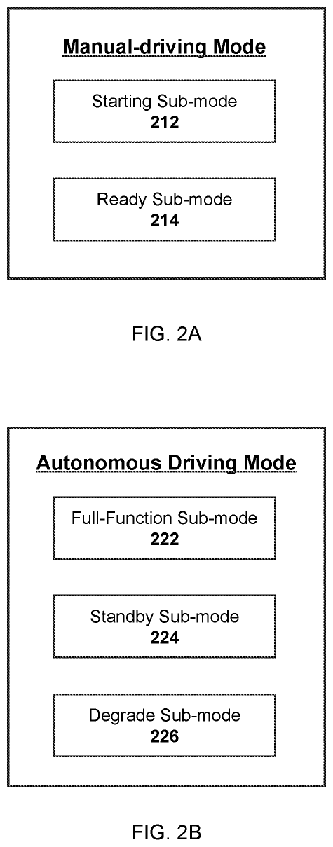

In some embodiments, the processing device 110 may be a single server or a server group. The server group may be centralized or distributed (e.g., the processing device 110 may be a distributed system). In some embodiments, the processing device 110 may be local or remote. For example, the processing device 110 may access information and/or data stored in the vehicle 130 and/or the storage device 140 via the network 120. As another example, the processing device 110 may be directly connected to the vehicle 130 and/or the storage device 140 to access stored information and/or data. In some embodiments, the processing device 110 may be implemented on a cloud platform or an onboard computer. Merely by way of example, the cloud platform may include a private cloud, a public cloud, a hybrid cloud, a community cloud, a distributed cloud, an inter-cloud, a multi-cloud, or the like, or any combination thereof. In some embodiments, the processing device 110 may be implemented on a computing device 300 including one or more components illustrated in FIG. 2 in the present disclosure.

In some embodiments, the processing device 110 may process information and/or data associated with driving information associated with the vehicle 130 to perform one or more functions described in the present disclosure. For example, the processing device 110 may obtain status information of the vehicle 130, where the status information may include a current driving mode of the vehicle 130. As another example, the processing device 110 may determine whether the status information of the vehicle 130 satisfies a mode switching condition. Further, the processing device 110 may designate a candidate driving mode that satisfies a mode switching condition as a target driving mode, and may switch the current driving mode into the target driving mode. As used herein, a driving mode may include a manual-driving mode (including a starting sub-mode and a ready sub-mode), an autonomous driving mode (including a full-function sub-mode, a standby sub-mode, and a degrade sub-mode), or a safe mode, etc. In some embodiments, the processing device 110 may include one or more processing engines (e.g., single-core processing engine(s) or multi-core processor(s)). Merely by way of example, the processing device 110 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

In some embodiments, the processing device 110 may be connected to the network 120 to communicate with one or more components (e.g., the vehicle 130, the storage device 140) of the vehicle system 100. In some embodiments, the processing device 110 may be directly connected to or communicate with one or more components (e.g., the vehicle 130, the storage device 140) of the vehicle system 100. In some embodiments, the processing device 110 may be integrated into the vehicle 130. For example, the processing device 110 may be a computing device (e.g., an on-board computer) installed in the vehicle 130.

The network 120 may facilitate the exchange of information and/or data. In some embodiments, one or more components (e.g., the processing device 110, the vehicle 130, or the storage device 140) of the vehicle system 100 may send information and/or data to other component(s) of the vehicle system 100 via the network 120. For example, the processing device 110 may obtain status information of the vehicle system 100 via the network 120. The status information may at least include a current driving mode of the vehicle 130. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points, through which one or more components of the vehicle system 100 may be connected to the network 120 to exchange data and/or information.

The vehicle 130 may be a vehicle of any type with an autonomous driving capability. Under a manual-driving mode, the vehicle 130 may be capable of driving under human intervention. Under an autonomous driving mode, the vehicle 130 may be capable of sensing environmental information and navigating without human maneuver. In some embodiments, the vehicle system 100 may include a vehicle platform including structures of a conventional vehicle (e.g., one or more engines, one or more wheels, one or more steering wheels, etc.), and an autonomous platform configured to drive the vehicle 130 autonomously. More descriptions regarding the vehicle 130 may be found elsewhere in the present disclosure. See, e.g., FIG. 1B and relevant descriptions thereof.

The storage device 140 may store data and/or instructions. In some embodiments, the storage device 140 may store data obtained from the vehicle system 100, such as status information associated with the vehicle system 100. In some embodiments, the storage device 140 may store data and/or instructions that the processing device 110 may execute or use to perform exemplary methods described in the present disclosure. In some embodiments, the storage device 140 may include a mass storage device, a removable storage device, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 140 may be connected to the network 120 to communicate with one or more components (e.g., the processing device 110, the vehicle 130) of the vehicle system 100. One or more components of the vehicle system 100 may access the data or instructions stored in the storage device 140 via the network 120. In some embodiments, the storage device 140 may be directly connected to or communicate with one or more components (e.g., the processing device 110, the vehicle 130) of the vehicle system 100. In some embodiments, the storage device 140 may be part of the processing device 110. In some embodiments, the storage device 140 may be integrated in the vehicle 130.

It should be noted that the vehicle system 100 is merely provided for the purposes of illustration, and is not intended to limit the scope of the present disclosure. For persons having ordinary skills in the art, multiple variations or modifications may be made under the teachings of the present disclosure. For example, the vehicle system 100 may further include a database, an information source, etc. As another example, the vehicle system 100 may be implemented on other devices to realize similar or different functions. However, those variations and modifications do not depart from the scope of the present disclosure.

FIG. 1B is a schematic diagram illustrating an exemplary vehicle with an autonomous driving capability according to some embodiments of the present disclosure. For example, the vehicle system 100 may at least include a vehicle platform and an autonomous platform, and the vehicle 130 may drive autonomously, or drive under human control.

The vehicle platform may be configured to drive the vehicle 130 with or without human maneuver. For example, the vehicle platform may include an Engine Management System (EMS) 132, an Electric Stability Control (ESC) 134, an Electric Power System (EPS) 136, a Steering Column Module (SCM) 138, a throttling system 1322, a braking system 1342, and a steering system 1382.

The autonomous platform may process information and/or data relating to vehicle driving (e.g., autonomous driving) to perform one or more functions described in the present disclosure. In some embodiments, the autonomous platform may be configured to drive the vehicle 130 autonomously. In some embodiments, the autonomous platform may include an autonomous control unit 150, and a plurality of sensors 1522, 1524, 1526. The autonomous control unit 150 may output a plurality of control signals. For example, the autonomous control unit 150 may determine a plurality of control signals for the vehicle 130 based on the environmental information and driving mode of the vehicle 130. The plurality of control signals may be configured to be received by a plurality of electronic control units (ECUs) to control the drive of the vehicle 130.

The plurality of sensors (e.g., a plurality of sensors 1522, 1524, 1526) may be configured to provide information that is used to control the vehicle 130. In some embodiments, the sensors may sense the status of the vehicle 130. The status of the vehicle 130 may include the real-time operation condition of the vehicle 130, environmental information around the vehicle 130, or the like, or any combination thereof.

Merely by way of example, the plurality of sensors may include a distance sensor, a velocity sensor, an acceleration sensor, a steering angle sensor, a traction-related sensor, a camera, and/or any sensor. The distance sensor (e.g., a radar, a LiDAR, an infrared sensor) may determine a distance between the vehicle 130 and other objects (e.g., an obstacle). The distance sensor may also determine a distance between the vehicle 130 and one or more obstacles (e.g., a static obstacle, a moving obstacle). The velocity sensor (e.g., a Hall effect sensor) may determine a velocity (e.g., an instantaneous velocity, an average velocity) of the vehicle 130. The acceleration sensor (e.g., an accelerometer) may determine an acceleration (e.g., an instantaneous acceleration, an average acceleration) of the vehicle 130. The steering angle sensor (e.g., a tilt sensor or a micro-gyroscope) may determine a steering angle of the vehicle 130. The traction-related sensor (e.g., a force sensor) may determine a traction of the vehicle 130.

As another example, the plurality of sensors may include one or more video cameras, laser-sensing systems, infrared-sensing systems, acoustic-sensing systems, thermal-sensing systems, or the like, or any combination thereof. The plurality of sensors may detect a road geometry and/or obstacles (e.g., a static obstacle, a moving obstacle). The road geometry may include a road width, road length, road type (e.g., ring road, straight road, one-way road, two-way road). Exemplary static obstacles may include a building, a tree, a roadblock, or the like, or any combination thereof. Exemplary moving obstacles may include a moving vehicle, a pedestrian, and/or an animal, or the like, or any combination thereof.

In some embodiments, the autonomous control unit 150 may include one or more processing engines (e.g., single-core processing engine(s) or multi-core processor(s)). Merely by way of example, the autonomous control unit 150 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

In some embodiments, the vehicle system 100 may include a gateway module 154. The gateway module 154 may determine a command source for the plurality of ECUs (e.g., the EMS 132, the EPS 136, the ESC 134, and the SCM 138) based on a current driving mode of the vehicle. The command source may be from a human driver, from the autonomous control unit 150, from the processing device 110, or the like, or any combination thereof.

The gateway module 154 may determine a current driving mode of the vehicle. The driving mode of the vehicle 130 may include a manual-driving mode, a semi-autonomous driving mode, an autonomous driving mode, a safe mode, or the like, or any combination thereof. For example, the gateway module 154 may determine the current driving mode of the vehicle 130 to be a manual-driving mode based on an input from a human driver. As another example, the gateway module 154 may determine the current driving mode of the vehicle 130 to be an autonomous driving mode when control signals are output by the autonomous control unit 150. As still another example, the gateway module 154 may determine the current driving mode of the vehicle 130 to be a safe mode when an abnormality (e.g., a signal interruption, a processor crash) occurs.

In some embodiments, the gateway module 154 may transmit operations of the human driver to the plurality of ECUs in response to a determination that the current driving mode of the vehicle 130 is a manual-driving mode. For example, the gateway module 154 may transmit a press operation to the accelerator of the vehicle 130 performed by a human driver to the EMS 132 in response to a determination that the current driving mode of the vehicle 130 is a manual-driving mode. The gateway module 154 may transmit control signals of the autonomous control unit 150 to the plurality of ECUs in response to a determination that the current driving mode of the vehicle 130 is an autonomous driving mode. For example, the gateway module 154 may transmit a control signal associated with a steering operation to the SCM 138 in response to a determination that the current driving mode of the vehicle 130 is an autonomous driving mode. The gateway module 154 may transmit the operations of the human driver and the control signals of the autonomous control unit 150 to the plurality of ECUs in response to a determination that the current driving mode of the vehicle 130 is a semi-autonomous driving mode. The gateway module 154 may transmit an error signal to the plurality of ECUs in response to a determination that the current driving mode of the vehicle 130 is a safe mode. In some embodiments, when the vehicle 130 is in the autonomous driving mode and receives a driver maneuver, the gateway module 154 may transmit the operation of the human driver to the plurality of ECUs.

In some embodiments, the vehicle system 100 may include a Controller Area Network (CAN) 160. The CAN 160 may be a robust vehicle bus standard (e.g., a message-based protocol) allowing microcontrollers (e.g., the autonomous control unit 150) and devices (e.g., the EMS 132, the EPS 136, the ESC 134, and/or the SCM 138, etc.) to communicate with each other in applications without a host computer. The CAN 160 may be configured to connect the autonomous control unit 150 with the plurality of ECUs (e.g., the EMS 132, the EPS 136, the ESC 134, or the SCM 138).

The EMS 132 may be configured to determine an engine performance of the vehicle 130. In some embodiments, the EMS 132 may determine the engine performance of the vehicle 130 based on the control signals from the autonomous control unit 150. For example, the EMS 132 may determine the engine performance of the vehicle 130 based on a control signal associated with an acceleration from the autonomous control unit 150 when the current driving mode is an autonomous driving mode. In some embodiments, the EMS 132 may determine the engine performance of the vehicle 130 based on operations of a human driver. For example, the EMS 132 may determine the engine performance of the vehicle 130 based on a press on the accelerator done by the human driver when the current driving mode is a manual-driving mode.

The EMS 132 may include a plurality of sensors and at least one microprocessor. The plurality of sensors may be configured to detect one or more physical signals and convert the one or more physical signals to electrical signals for processing. In some embodiments, the plurality of sensors may include a variety of temperature sensors, an air flow sensor, a throttle position sensor, a pump pressure sensor, a speed sensor, an oxygen sensor, a load sensor, a knock sensor, or the like, or any combination thereof. The one or more physical signals may include, but not limited to, an engine temperature, an engine intake air volume, a cooling water temperature, an engine speed, or the like, or any combination thereof. The microprocessor may determine the engine performance based on a plurality of engine control parameters. The microprocessor may determine the plurality of engine control parameters based on the plurality of electrical signals. The plurality of engine control parameters may be determined to optimize the engine performance. The plurality of engine control parameters may include an ignition timing, a fuel delivery, an idle air flow, or the like, or any combination thereof.

The throttling system 1322 may be configured to change motions of the vehicle 130. For example, the throttling system 1322 may determine a velocity of the vehicle 130 based on an engine output. As another example, the throttling system 1322 may cause an acceleration of the vehicle 130 based on the engine output. The throttling system 1322 may include fuel injectors, a fuel pressure regulator, an auxiliary air valve, a temperature switch, a throttle, an idling speed motor, a fault indicator, ignition coils, relays, or the like, or any combination thereof.

In some embodiments, the throttling system 1322 may be an external executor of the EMS 132. The throttling system 1322 may be configured to control the engine output based on the plurality of engine control parameters determined by the EMS 132.

The ESC 134 may be configured to improve the stability of the vehicle 130. For example, the ESC 134 may improve the stability of the vehicle 130 by detecting and/or compansating loss of traction. In some embodiments, the ESC 134 may control operations of the braking system 1342 to help steer the vehicle 130 in response to a determination that a loss of steering control is detected by the ESC 134. For example, the ESC 134 may improve the stability of the vehicle 130 when the vehicle 130 starts on an uphill slope by braking. In some embodiments, the ESC 134 may further control the engine performance to improve the stability of the vehicle. For example, the ESC 134 may reduce an engine power when a probable loss of steering control happens. The loss of steering control may happen when the vehicle 130 skids during an emergency evasive swerve, when the vehicle 130 understeers or oversteers during poorly judged turns on slippery roads, etc.

The braking system 1342 may be configured to control a motion state of the vehicle 130. For example, the braking system 1342 may decelerate the vehicle 130. As another example, the braking system 1342 may stop the vehicle 130 in one or more road conditions (e.g., a downhill slope). As still another example, the braking system 1342 may keep the vehicle 130 at a constant velocity when the vehicle 130 travels on a downhill slope.

The braking system 1342 may include a mechanical control component, a hydraulic unit, a power unit (e.g., a vacuum pump), an executing unit, or the like, or any combination thereof. The mechanical control component may include a pedal, a handbrake, etc. The hydraulic unit may include a hydraulic oil, a hydraulic hose, a brake pump, etc. The executing unit may include a brake caliper, a brake pedal, a brake disc, etc.

The EPS 136 may be configured to control the electric power supply of the vehicle 130. The EPS 136 may supply, transfer, and/or store electric power for the vehicle 130. For example, the EPS 136 may include one or more batteries and alternators. An alternator may be configured to charge the battery, and the battery may be connected to other parts of the vehicle 130 (e.g., a starter to provide power). In some embodiments, the EPS 136 may control power supply to the steering system 1382. For example, the EPS 136 may supply a large amount of electric power to the steering system 1382 to create a large steering torque for the vehicle 130, in response to a determination that the vehicle 130 needs to conduct a sharp turn (e.g., turning a steering wheel all the way to the left or all the way to the right).

The SCM 138 may be configured to control the steering wheel of the vehicle 130. For example, the SCM 138 may lock/unlock the steering wheel of the vehicle 130. In some embodiments, the SCM 138 may lock/unlock the steering wheel of the vehicle 130 based on a current driving mode of the vehicle 130. For example, the SCM 138 may lock the steering wheel of the vehicle 130 in response to a determination that the current driving mode is an autonomous driving mode. The SCM 138 may further retract a steering column shaft in response to a determination that the current driving mode is an autonomous driving mode. As another example, the SCM 138 may unlock the steering wheel of the vehicle 130 in response to a determination that the current driving mode is a semi-autonomous driving mode, a manual-driving mode, and/or a safe mode.

The SCM 138 may control the steering of the vehicle 130 based on the control signals of the autonomous control unit 150. The control signals may include information related to a turning direction, a turning location, a turning angle, or the like, or any combination thereof.

The steering system 1382 may be configured to steer the vehicle 130. In some embodiments, the steering system 1382 may steer the vehicle 130 based on signals transmitted from the SCM 138. For example, the steering system 1382 may steer the vehicle 130 based on the control signals of the autonomous control unit 150 transmitted from the SCM 138 in response to a determination that the current driving mode is an autonomous driving mode. In some embodiments, the steering system 1382 may steer the vehicle 130 based on operations of a human driver. For example, the steering system 1382 may turn the vehicle 130 to a left direction when the human driver turns the steering wheel to a left direction in response to a determination that the current driving mode is a manual-driving mode.

In some embodiments, the vehicle 130 may include an interface for a driver to interact with the vehicle system 100. For example, the interface may display an icon for each of the manual-driving mode, the autonomous driving mode, and the safe mode. The driver may switch a driving mode via the interface through an oral instruction, text instruction, or pressing an icon corresponding to the driving mode, etc.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the vehicle system 100 may include a transmission system capable of selecting a gear for the vehicle 130. As another example, the vehicle system 100 may include an actuator for actuating the autonomous platform.

FIG. 2A is a block diagram illustrating an exemplary manual-driving mode according to some embodiments of the present disclosure. The manual-driving mode may be a mode in which the vehicle 130 is driving under human control, and the gateway module 154 may transmit human operations to the plurality of ECUs (e.g., the EMS 132, the EPS 136, the ESC 134, and the SCM 138). Operations in the manual-driving mode may include providing mechanical input and transferring the mechanical input to the vehicle platform. For example, the steering system 1382 may be connected or in communication with a steering wheel for manual operation. When a driver turns the steering wheel, a shaft connecting the steering wheel may turn a gear that is intermeshed with a rack. The rack may connect the front wheels of the vehicle 130 and may cause the front wheels to tum in the appropriate direction based on the mechanical input.

In some embodiments, the manual-driving mode may further include a starting sub-mode 212 and a ready sub-mode 214. The starting sub-mode 212 may be a mode into which the vehicle system 100 enters immediately after an engine of the vehicle 130 is started. In the starting sub-mode 212, the vehicle platform and/or the autonomous platform may be not yet ready for the vehicle 130 to drive autonomously. For example, the autonomous control unit 150 may start an initializing process after the vehicle 130 is started, and may be not yet ready for generating control signals. As another example, the gateway module 154 may be not yet ready for determining command sources.

In some embodiments, the vehicle system 100 may enter a self-examination process to detect whether there is an error in the vehicle platform and/or the autonomous platform after a certain time period or the vehicle system 100 receives an instruction from a user. If there is no error detected in the vehicle platform and the autonomous platform, the processing device 110 may switch the vehicle system 100 from the starting sub-mode 212 to the ready sub-mode 214. The ready sub-mode 214 may be a mode in which the vehicle system 100 functions well and is ready to enter an autonomous driving mode. Under the ready sub-mode 214, the vehicle platform and/or the autonomous platform may be functionally ready for the vehicle 130 to drive autonomously. In some embodiments, the time period may be predetermined by a user, e.g., 1 minute after the vehicle 130 is started. In some embodiments, the time period may be determined automatically by the vehicle system 100. For example, the vehicle system 100 may enter the self-examination process after the engine runs smoothly.

FIG. 2B is a block diagram illustrating an exemplary autonomous driving mode according to some embodiments of the present disclosure. The autonomous driving mode may be a mode in which at least a portion of the vehicle 130 is under computer control including, for example, robotic or remote operation. Under robotic control, the autonomous control unit 150 may output a plurality of control signals to the plurality of electronic control units (ECUs) to control the driving of the vehicle 130. Under remote operation, a user (different from the driver) may pilot the vehicle 130 remotely using a remote monitor and control system, e.g., a user may pilot the vehicle 130 remotely through the processing device 110 via the network 120. The remote monitor may rely on cameras or sensors, such as the plurality of sensors 1522, 1524, 1526, to determine a position and a status of the vehicle 130.

In some embodiments, the autonomous driving mode may include a full-function sub-mode 222, a standby sub-mode 224, and a degrade sub-mode 226. The full-function sub-mode may be a mode in which the vehicle system 100 is fully functional and the vehicle 130 may drive autonomously. For example, the vehicle system 100 may handle all driving tasks independently in the full-function sub-mode 222, such as driving path planning, obstacle avoidance, speed control, stability control, etc. In the full-function sub-mode, the vehicle platform and/or the autonomous platform may be monitored in real-time to detect failures such as hardware damage, data transmission congestion, etc. If any failure is detected, the vehicle system 100 may switch the vehicle from the full-function sub-mode 222 to another mode for handling emergencies (e.g., the degrade sub-mode 226).

After the vehicle system 100 receives a request from a driver for taking over the vehicle 130 during an autonomous drive process, the processing device 110 may switch the vehicle system 100 from the full-function sub-mode 222 to the standby sub-mode 224. The standby sub-mode 224 may be a transition mode between the full-function sub-mode 222 and the manual driving mode. In the standby sub-mode 224, the vehicle system 100 may wait for a user to take over the vehicle 130. The gateway module 154 may prepare for switching the control commands source from the autonomous control unit 150 to the driver.

Either in the full-function sub-mode 222 or in the standby sub-mode 224, the vehicle 130 may continue driving autonomously. When there is a failure or error (e.g., a single sensor failure, a single processor failure, etc.) detected in the vehicle system 100 and the vehicle system 100 can resolve the failure or error without human intervention while the vehicle 130 is running or after the vehicle 130 is stopped, the processing device 110 may switch the full-function sub-mode 222 or the standby sub-mode 224 to the degrade sub-mode 226. Such a failure or error that the vehicle system 100 can resolve without human intervention while the vehicle 130 is running or after the vehicle 130 is stopped may be referred to as a handleable failure or error, or resolvable failure or error, or correctable failure or error. The degrade sub-mode 226 may be a mode in which the vehicle 130 continues to run but at least some functions of the vehicle system 100 are degraded in order to resolve the detected failure(s) or prepare for stopping the car when the vehicle system 100 detects a resolvable failure (e.g., a single sensor failure, a single processor failure, etc.).

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more driving modes of the vehicle system 100 described above may be omitted or be replaced by any other modes that can perform the same or similar functions. For example, the vehicle system 100 may include a semi-autonomous driving mode in addition to or replacing the standby sub-mode 224. Under the semi-autonomous driving mode, the vehicle 130 may switch from an autonomous driving to a human driving.

In some embodiments, the vehicle system 100 may include one or more additional driving modes. For example, the vehicle system 100 may include a safe mode. When the vehicle system 100 has a failure (e.g., a processor crash, an ECU failure, etc.), and neither the driver nor the autonomous platform (e.g., the autonomous control unit 150) may be capable of taking full control of the vehicle 130, the processing device 110 may switch a current driving mode (e.g., the full-function sub-mode 222, the standby sub-mode 224, or the degrade sub-mode 226) to the safe mode. The safe mode may be a mode in which the vehicle 130 may drive according to a default instruction when the vehicle system 100 has a failure that cannot beresolved automatically when the vehicle 130 is running. The vehicle 130 may then drive according to the default instruction, for example, straightening the steering wheel slowly, and slowing down the vehicle 130 until the vehicle 130 stops.

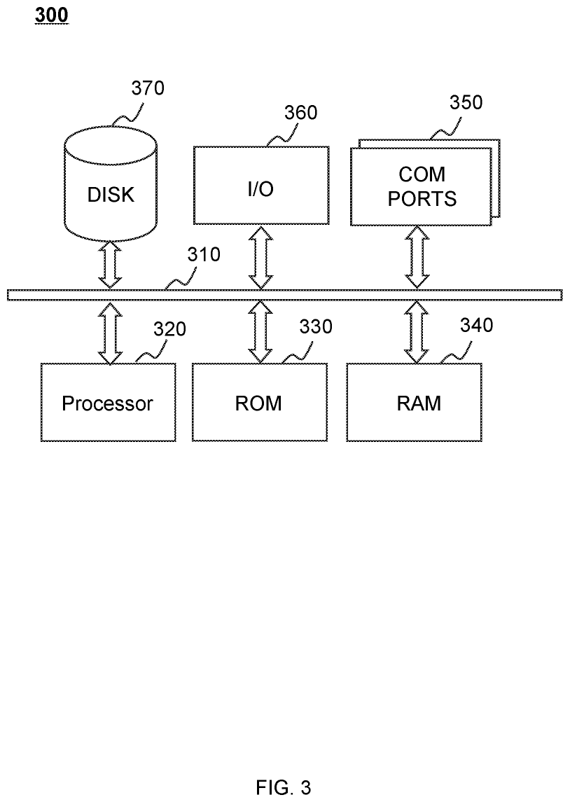

FIG. 3 is a schematic diagram illustrating exemplary hardware and/or software components of an exemplary computing device according to some embodiments of the present disclosure. In some embodiments, the processing device 110 may be implemented on the computing device 300. For example, the processing device 110 may be implemented on the computing device 300 and configured to perform functions of the processing device 110 disclosed in this disclosure.

The computing device 300 may be used to implement any component of the vehicle system 100 of the present disclosure. For example, the processing device 110 of the vehicle system 100 may be implemented on the computing device 300, via its hardware, software program, firmware, or a combination thereof. Although only one such computer is shown for convenience, the computer functions associated with the vehicle system 100 as described herein may be implemented in a distributed manner on a number of similar platforms to distribute the processing load.

The computing device 300, for example, may include communication (COMM) ports 350 connected to and from a network (e.g., the network 120) connected thereto to facilitate data communications. The computing device 300 may also include a processor (e.g., a processor 320), in the form of one or more processors (e.g., logic circuits), for executing program instructions. For example, the processor may include interface circuits and processing circuits therein. The interface circuits may be configured to receive electronic signals from a bus 310, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 310.

The computing device 300 may further include program storage and data storage of different forms, for example, a disk 370, and a read only memory (ROM) 330, or a random access memory (RAM) 340, for storing various data files to be processed and/or transmitted by the computing device 300. The computing device 300 may also include program instructions stored in the ROM 330, the RAM 340, and/or other type of non-transitory storage medium to be executed by the processor 320. The methods and/or processes of the present disclosure may be implemented as the program instructions. The computing device 300 also includes an I/O component 360, supporting input/output between the computing device 300 and other components therein. The computing device 300 may also receive programming and data via network communications.

Merely for illustration, only one processor is described in the computing device 300. However, it should be noted that the computing device 300 in the present disclosure may also include multiple processors, and thus operations that are performed by one processor as described in the present disclosure may also be jointly or separately performed by the multiple processors. For example, the processor of the computing device 300 executes both operation A and operation B. As in another example, operation A and operation B may also be performed by two different processors jointly or separately in the computing device 300 (e.g., the first processor executes operation A and the second processor executes operation B, or the first and second processors jointly execute operations A and B).

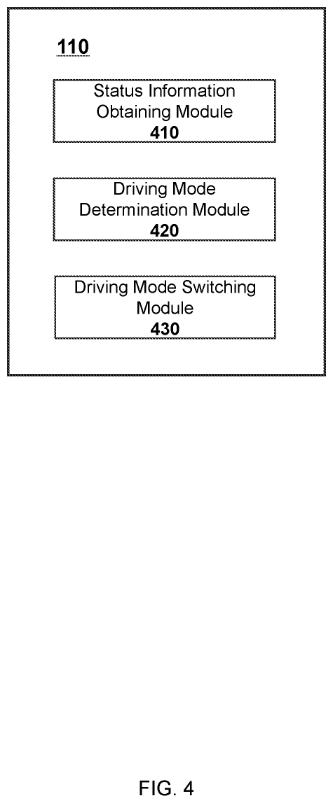

FIG. 4 is a block diagram illustrating an exemplary processing device according to some embodiments of the present disclosure. The processing device 110 may include a status information obtaining module 410, a driving mode determination module 420, and a driving mode switching module 430.

The status information obtaining module 410 may be configured to obtain status information of the vehicle system 100. In some embodiments, the status information may include information associated with the driving of the vehicle 130. The status information may include operation status information of the vehicle platform, operation status information of the autonomous platform, or a user instruction received by the vehicle system 100, or the like, or any combination thereof. In some embodiments, the status information may include a current driving mode of the vehicle system 100. The current driving mode may refer to a driving mode the vehicle system being in when the status information of the vehicle system 100 is obtained. The driving mode may include a starting sub-mode (e.g., the starting sub-mode 212), a ready sub-mode (e.g., the ready sub-mode 214), a full-function sub-mode (e.g., the full-function sub-mode 222), a standby sub-mode (e.g., the standby sub-mode 224), a degrade sub-mode (e.g., the degrade sub-mode 226), or a safe mode, etc.

The driving mode determination module 420 may be configured to obtain at least one mode switching condition. The mode switching condition herein may refer to a preset condition. If the preset condition is satisfied, the driving mode of the vehicle system 100 may be switched to a preset driving mode. The preset driving mode may be also referred to as a candidate driving mode corresponding to the mode switching condition. In some embodiments, each of the at least one mode switching condition may correspond to a candidate driving mode that triggers switching the vehicle system 100 from the current driving mode to the candidate driving mode. The at least one mode switching condition may include a first mode switching condition, a second mode switching condition, a third mode switching condition, a fourth mode switching condition, and a fifth mode switching condition. The first mode switching condition may include that the vehicle system 100 receives an instruction for manual operation from a driver when the vehicle system 100 is currently in the full-function sub-mode. The candidate driving mode corresponding to the first mode switching condition may include the standby sub-mode. The second mode switching condition may include that there is no manual operations (e.g., taking over the steer wheel, stepping on the accelerator pedal, etc.) detected within a time period when the vehicle system 100 is currently in the standby sub-mode. The candidate driving mode corresponding to the second mode switching condition may include the full-function sub-mode. The third mode switching condition may include that there is a correctable failure detected in the vehicle system 100 when the vehicle system 100 is currently in the full-function sub-mode or the standby sub-mode. The candidate driving mode corresponding to the third mode switching condition may include the degrade sub-mode. The fourth mode switching condition may include that the correctable failure is solved when the vehicle is currently in the degrade sub-mode. The candidate driving mode corresponding to the fourth mode switching condition may include the full-function sub-mode or the standby sub-mode. The fifth mode switching condition may include that there is no failure detected either in the vehicle platform and/or in the autonomous platform when the vehicle is currently in the starting sub-mode. The candidate driving mode corresponding to the fifth mode switching condition may include the ready sub-mode.

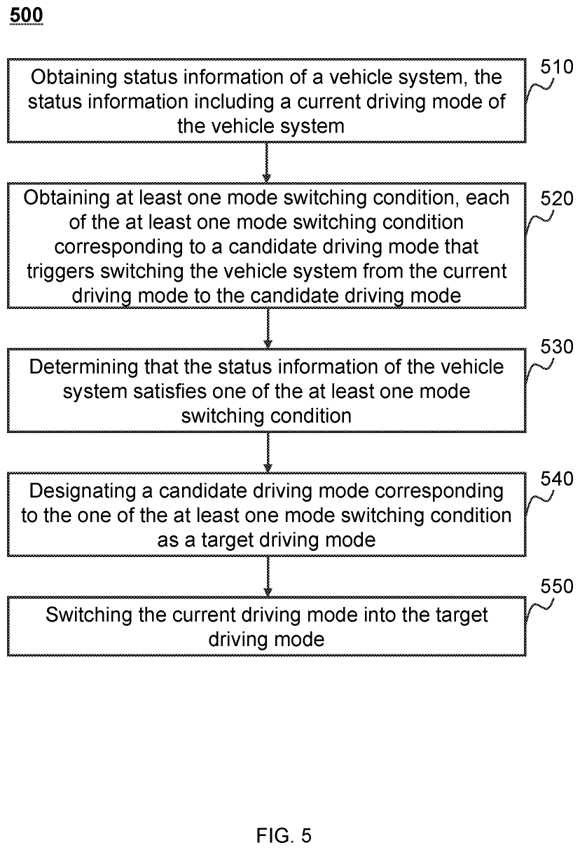

The driving mode determination module 420 may also be configured to determine that the status information of the vehicle system 100 satisfies one of the at least one mode switching condition. The determination may be initiated by the processing device 110 automatically periodically (e.g., every 1 second, every 2 seconds, every 3 seconds) and/or when a condition is satisfied (e.g., when at least a certain time period has lapsed without a driver maneuver of the vehicle 130, when the vehicle system 100 receives a user instruction or driver maneuver of the vehicle 130). In some embodiments, the processing device 110 may compare the status information with the at least one mode switching condition. For example, when the vehicle system 100 is currently in the full-function sub-mode, the processing device 110 may determine whether the vehicle system 100 receives an instruction for manual operation from the driver. If the vehicle system 100 receives an instruction for manual operation from the driver when the vehicle system 100 is in the full-function sub-mode, the processing device 110 may determine that the status information of the vehicle system 100 satisfies the first mode switching condition. More descriptions regarding the determination may be found elsewhere in the present disclosure. See, e.g., FIG. 5 and relevant descriptions thereof.

The driving mode determination module 420 may further be configured to designate a candidate driving mode corresponding to the one of the at least one mode switching condition as a target driving mode. For example, if it is determined that the status information of the vehicle system 100 satisfies the first mode switching condition, the processing device 110 may designate the standby sub-mode (the candidate driving mode) corresponding to the first mode switching condition as the target driving mode. More descriptions regarding the designation may be found elsewhere in the present disclosure. See, e.g., FIG. 5 and relevant descriptions thereof.

The driving mode switching module 430 may be configured to switch the current driving mode into the target driving mode. For example, if the full-function sub-mode (the candidate driving mode) corresponding to the second mode switching condition is designated as the target driving mode, the processing device 110 may switch the vehicle system 100 from the standby sub-mode (the current driving mode) to the full-function sub-mode (the target driving mode). As another example, if the ready sub-mode (the candidate driving mode) corresponding to the fifth mode switching condition is designated as the target driving mode, the processing device 110 may switch the vehicle system 100 from the starting sub-mode (the current driving mode) to the ready sub-mode (the target driving mode).

The modules in the processing device 110 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Any two of the modules may be combined as a single module, any one of the modules may be divided into two or more units.

For example, the status information obtaining module 410 and the driving mode determination module 420 may be combined as a single module which may both receive/obtain the status information of the vehicle system 100 and the at least one mode switching condition. As another example, the driving mode determination module 420 may be divided into three units including a switching condition obtaining unit, a condition satisfying determination unit, and a target driving mode determination unit. The switching condition obtaining unit may be configured to obtain the at least one mode switching condition, the condition satisfying determination unit may be configured to determine that the status information of the vehicle system 100 satisfies one of the at least one mode switching condition, and the target driving mode determination unit may be configured to designate a candidate driving mode corresponding to the one of the at least one mode switching condition that is determined as being satisfied as a target driving mode. As a further example, the processing device 110 may include a storage module (not shown) which may be configured to store information and/or data (e.g., the status information, the at least one mode switching condition, the candidate driving mode, the target driving mode) associated with the status and/or driving mode of the vehicle system 100.

FIG. 5 is a flowchart illustrating an exemplary process for driving mode switching according to some embodiments of the present disclosure. The process 500 may be executed by the vehicle system 100. For example, the process 500 may be implemented as a set of instructions stored in the storage ROM 330 or RAM 340. The processor 320 and/or the modules in FIG. 3 may execute the set of instructions, and when executing the instructions, the processor 320 and/or the modules may be configured to perform the process 500. The operations of the illustrated process presented below are intended to be illustrative. In some embodiments, the process 500 may be accomplished with one or more additional operations not described and/or without one or more of the operations discussed. Additionally, the order in which the operations of the process 500 illustrated in FIG. 5 and described below is not intended to be limiting.

In 510, the processing device 110 (e.g., the status information obtaining module 410) may obtain status information of the vehicle system 100. In some embodiments, the status information may include information associated with the driving of the vehicle 130. For example, the status information may include operation status information of the vehicle platform, such as energy performance, driving stability, whether the brake is effective, whether the steering is precise, etc. As another example, the status information may include operation status information of the autonomous platform, such as whether the autonomous control unit 150 outputs control signals timely, whether there is an interruption between the control signals and the plurality of ECUs, whether a signal crash occurs in any one of a plurality of sensors, e.g., 1522, 1524, 1526, etc. As still another example, the status information may include a user instruction received by the vehicle system 100. The user instruction may include an instruction for switching a driving mode, whether the user steps on the braking pedal, whether the user handles the steering wheel (e.g., with a certain torque), whether the user has fastened the seat belt, whether the user turns on a turn signal light, etc. As a further example, the status information may include a current driving mode of the vehicle system 100. As used herein, the current driving mode refers to a driving mode the vehicle system being in when the status information of the vehicle system 100 is obtained. The driving mode may include a starting sub-mode (e.g., the starting sub-mode 212), a ready sub-mode (e.g., the ready sub-mode 214), a full-function sub-mode (e.g., the full-function sub-mode 222), a standby sub-mode (e.g., the standby sub-mode 224), a degrade sub-mode (e.g., the degrade sub-mode 226), or a safe mode, etc.

In 520, the processing device 110 (e.g., the driving mode determination module 420) may obtain at least one mode switching condition. The mode switching condition herein refers to a preset condition. If the preset condition is satisfied, the driving mode of the vehicle system 100 may be switched to a preset driving mode. The preset driving mode may be also referred to as a candidate driving mode corresponding to the mode switching condition. In some embodiments, each of the at least one mode switching condition may correspond to a candidate driving mode that triggers switching the vehicle system 100 from the current driving mode to the candidate driving mode. For example, the at least one mode switching condition may include a first mode switching condition that triggers switching the vehicle system 100 from the full-function sub-mode (the current driving mode) to the standby sub-mode (a candidate driving mode), the first mode switching condition may relate to an instruction for manual operation received from the driver. The instruction that the driver input for manual operation may include a voice command, a text instruction, pressing a virtual icon corresponding to the standby sub-mode on an interface, or pressing a mode switching button, etc. As another example, the at least one mode switching condition may include a second mode switching condition that triggers switching the vehicle system 100 from the standby sub-mode (the current driving mode) to the full-function sub-mode (a candidate driving mode), the second mode switching condition may be that no manual operations (e.g., taking over the steer wheel, stepping on the accelerator pedal, etc.) is detected within a time period. In some embodiments, the time period may be predetermined by the vehicle system 100. For example, the time period may be 5 seconds. As still another example, the at least one mode switching condition may include a third mode switching condition that triggers switching the vehicle system 100 from the full-function sub-mode (the current driving mode) or the standby sub-mode (the current driving mode) to the degrade sub-mode (a candidate driving mode), the third mode switching condition may be that there is a correctable failure detected in the vehicle system 100. The correctable failure may include, e.g., a single sensor failure, a short-term data transmission congestion, etc., which can be handled by the vehicle system 100. As still another example, the at least one mode switching condition may include a fourth mode switching condition that triggers switching the vehicle system 100 from the degrade sub-mode (the current driving mode) to the full-function sub-mode (a candidate driving mode) or the standby sub-mode (a candidate driving mode), the fourth mode switching condition may be that the correctable failure is solved. As a further example, the at least one mode switching condition may include a fifth mode switching condition that triggers switching the vehicle system 100 from the starting sub-mode (the current driving mode) to the ready sub-mode (a candidate driving mode), the fifth mode switching condition may be that there is no failure detected either in the vehicle platform or in the autonomous platform.

In 530, the processing device 110 (e.g., the driving mode determination module 420) may determine that the status information of the vehicle system 100 satisfies one of the at least one mode switching condition. The determination may be initiated by the processing device 110 automatically periodically (e.g., every 1 second, every 2 seconds, every 3 seconds) and/or when a condition is satisfied (e.g., when at least a certain time period has lapsed without a driver maneuver of the vehicle 130, when the vehicle system 100 receives a user instruction or driver maneuver of the vehicle 130). In some embodiments, the processing device 110 may compare the status information with the at least one mode switching condition. If one of the at least one mode switching condition is satisfied, the processing device 110 may determine that the status information of the vehicle system 100 satisfies the one of the at least one mode switching condition. For example, when the vehicle system 100 is currently in the full-function sub-mode, the processing device 110 may determine whether the vehicle system 100 receives an instruction for manual operation from the driver. If the vehicle system 100 receives an instruction for manual operation from the driver when the vehicle system 100 is in the full-function sub-mode, the processing device 110 may determine that the status information of the vehicle system 100 satisfies the first mode switching condition. As another example, when the vehicle system 100 is currently in the standby sub-mode, the processing device 110 may determine whether there is a manual operation (e.g., taking control of the steering wheel, stepping on the accelerator pedal, etc.) received within a time period. If there is no manual operation received within a time period, the processing device 110 may determine that the status information of the vehicle system 100 satisfies the second mode switching condition. As still another example, when the vehicle system 100 is currently in the full-function sub-mode or the standby sub-mode, the processing device 110 may determine whether there is a correctable failure (e.g., a single sensor failure, a short-term data transmission congestion, etc.) in the vehicle system 100. If there is a correctable failure in the vehicle system 100, the processing device 110 may determine that the status information of the vehicle system 100 satisfies the third mode switching condition. As still another example, when the vehicle system 100 is currently in the degrade sub-mode, the processing device 110 may determine whether the correctable failure is solved. If the correctable failure is solved, the processing device 110 may determine that the status information of the vehicle system 100 satisfies the fourth mode switching condition. As still another example, when the vehicle system 100 is currently in the starting sub-mode, the processing device 110 may determine whether there is a failure detected in the vehicle platform and the autonomous platform. If there is a failure is detected neither in the vehicle platform nor in the autonomous platform, the processing device 110 may determine that the status information of the vehicle system 100 satisfies the fifth mode switching condition.

In 540, the processing device 110 (e.g., the driving mode determination module 420) may designate a candidate driving mode corresponding to the one of the at least one mode switching condition as a target driving mode. For example, if it is determined that the status information of the vehicle system 100 satisfies the first mode switching condition, the processing device 110 may designate the standby sub-mode (the candidate driving mode) corresponding to the first mode switching condition as the target driving mode. As another example, if it is determining that the status information of the vehicle system 100 satisfies the second mode switching condition, the processing device 110 may designate the full-function sub-mode (the candidate driving mode) corresponding to the second mode switching condition as the target driving mode. As still another example, if it is determining that the status information of the vehicle system 100 satisfies the third mode switching condition, the processing device 110 may designate the degrade sub-mode (the candidate driving mode) corresponding to the third mode switching condition as the target driving mode. As still another example, if it is determined that the status information of the vehicle system 100 satisfies the fourth mode switching condition, the processing device 110 may designate one of the full-function sub-mode (the candidate driving mode) and the standby sub-mode (the candidate driving mode) corresponding to the fourth mode switching condition as the target driving mode. As still another example, if it is determined that the status information of the vehicle system 100 satisfies the fifth mode switching condition, the processing device 110 may designate the ready sub-mode (the candidate driving mode) corresponding to the fifth mode switching condition as the target driving mode.

In 550, the processing device 110 (e.g., the driving mode switching module 430) may switch the current driving mode into the target driving mode. For example, if the full-function sub-mode (the candidate driving mode) corresponding to the second mode switching condition is designated as the target driving mode, the processing device 110 may switch the vehicle system 100 from the standby sub-mode (the current driving mode) to the full-function sub-mode (the target driving mode). As another example, if the ready sub-mode (the candidate driving mode) corresponding to the fifth mode switching condition is designated as the target driving mode, the processing device 110 may switch the vehicle system 100 from the starting sub-mode (the current driving mode) to the ready sub-mode (the target driving mode).

In some embodiments, the processing device 110 may determine whether the status information of the vehicle system 100 satisfies a mode switching condition corresponding to the target driving mode in advance. Merely by way of example, the mode switching condition corresponding to the target driving mode may include whether function performance of the vehicle platform and/or the autonomous platform meets requirements of the target driving mode. In some embodiments, the mode switching condition corresponding to the target driving mode may include one or more customization conditions. A customization condition refers to a condition set a user (e.g., a driver, a technician) for entering the autonomous driving mode. If a customization condition is satisfied, the processing device 110 may switch the vehicle system 100 from a current driving mode into a candidate driving mode (e.g., an autonomous driving mode) corresponding to the customization condition. The one or more customization conditions may include whether the driver steps on the braking pedal, whether the driver handles the steering wheel (e.g., with a certain torque), whether the driver attaches the seat belt, whether the driver turns on a steering lamp, or the speed of the vehicle 130 is lower than a certain value, etc.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, the at least one mode switching condition may include a user instruction that triggers switching the vehicle 130 from the current driving mode to a target driving mode. As another example, one or more other optional operations (e.g., a storing operation) may be added elsewhere in the process 500. In the storing operation, the processing device 110 may store information and/or data (e.g., the status information of the vehicle system 100, the mode switching condition information, the target driving mode) associated with the driving mode switching in a storage device (e.g., the storage device 140) disclosed elsewhere in the present disclosure.

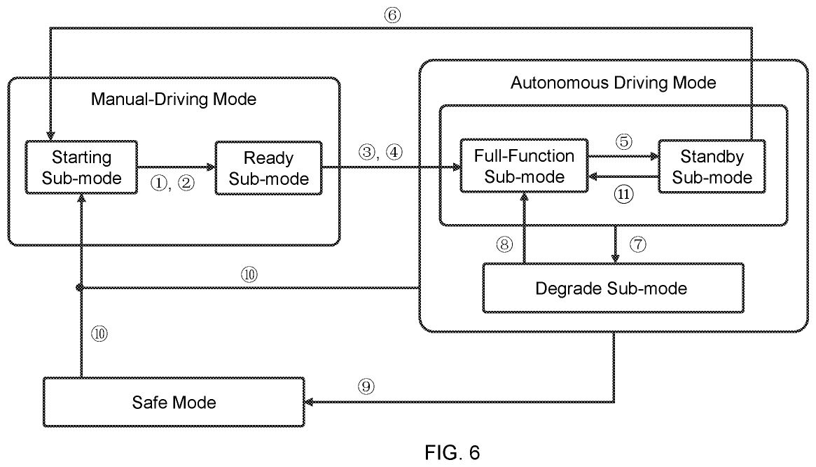

FIG. 6 is a schematic diagram illustrating an exemplary process for driving mode switching according to some embodiments of the present disclosure. As illustrated in FIG. 6, the vehicle system 100 may include a manual-driving mode, an autonomous driving mode, and a safe mode. The manual-driving mode may include a starting sub-mode and a ready sub-mode. The autonomous driving mode may include a full-function sub-mode, a standby sub-mode, and a degrade sub-mode. In some embodiments, both the full-function sub-mode and the standby sub-mode may be full-function. Mode switching conditions corresponding to the driving modes including the starting sub-mode, the ready sub-mode, the full-function sub-mode, the standby sub-mode, the degrade sub-mode, and the safe mode may be illustrated in Table 1 in combination with FIG. 6. A serial number in the Table 1 may correspond to a same serial number as shown in the FIG. 6.

The condition (i.e., the mode switching condition) VehiclePlatform_Error with a condition value of 0 may be that there is no error in the vehicle platform. The condition AutonomousPlatform_Error with a condition value of 0 may be that there is no error in the autonomous platform. The condition EngagedKey_On with a condition value of 1 may be that the driver inputs an instruction intended to switch the vehicle system 100 into the autonomous driving mode. The condition CustomizationConditionEngaged_On with a value of 1 may be that one or more customization condition for entering the autonomous driving mode is satisfied. The condition DisengagedKey_On with a value of 1 may be that the vehicle system 100 receives a request from the driver for taking over the vehicle 130. The condition CustomizationConditionDisengaged_On with a value of 1 may be that a manual operation is detected within a preset time period. The condition Handleable Error with a value of 1 may be that a handleable or resolvable failure (e.g., a single sensor failure, a short-term data transmission congestion, etc.) is detected in the vehicle system 100 and/or the vehicle system 100. The condition HandleableError_Clear with a value of 1 may be that a handleable error is solved by the vehicle system 100. The condition UnHandleable_Error with a value of 1 may be that the vehicle system 100 cannot handle an error. The condition DriverTakeoverAction with a value of 1 may be that a manual operation is detected by the vehicle system 100 when the vehicle system 100 can not handle a failure in the vehicle platform or an autonomous platform. The condition TimeOut_On with a value of 1 may be that no manual operation is detected within a preset time period.

TABLE 1

| Serial | | Condition |
|---|---|---|
| Number | Condition | Value |
| \textcircled{1} | VehiclePlatform_Error | 0 |
| \textcircled{2} | AutonomousPlatform_Error | 0 |
| \textcircled{3} | EngagedKey_On | 1 |
| \textcircled{4} | CustomizationConditionEngaged_On | 1 |
| \textcircled{5} | DisengagedKey_On | 1 |
| \textcircled{6} | CustomizationConditionDisengaged_On | 1 |
| \textcircled{7} | Handleable_Error | 1 |
| \textcircled{8} | HandleableError_Clear | 1 |
| \textcircled{9} | UnHandleable_Error | 1 |
| \textcircled{10} | DriverTakeoverAction | 1 |
| \textcircled{11} | TimeOut_On | 1 |

When the vehicle 130 is started by a driver, the vehicle system 100 may enter into the starting sub-mode immediately. In the starting sub-mode, the vehicle platform and/or the autonomous platform may not be ready for the vehicle 130 to drive autonomously. After the engine of the vehicle 130 runs smoothly (e.g., with a revolving speed of 800 rounds per minute or higher) or the vehicle system 100 receives an instruction from the driver, the vehicle system 100 may start a self-examination process to check whether there is a failure detected in the vehicle platform and the autonomous platform. If a failure is detected neither in the vehicle platform nor in the autonomous platform, the condition value of the condition VehiclePlatform_Error and the condition AutonomousPlatform_Error may be equal to 0. The processing device 110 may switch the vehicle system 100 from the starting sub-mode to the ready sub-mode. In the ready sub-mode, the performance of the vehicle platform and/or the autonomous platform may meet the requirement of the vehicle 130 to drive autonomously. If the driver input an instruction (e.g., a voice command, a text instruction, pressing an icon corresponding to the full-function sub-mode on an interface, or pressing a button to enter into the full-function sub-mode) intended to enter the autonomous driving mode, the condition value of the condition EngagedKey_On may be equal to 1. The processing device 110 may further determine whether the status of the vehicle system 100 satisfies one or more customization conditions. Exemplary customization conditions may include whether the driver steps on the braking pedal, whether the driver handles the steering wheel (e.g., with a certain torque), whether the driver has fastened the seat belt, or whether the speed of the vehicle 130 is lower than a certain value, etc. If all the one or more customization conditions are satisfied, the condition value of CustomizationConditionEngaged_On may be equal to 1. The processing device 110 may switch the vehicle system 100 from the ready sub-mode to the full-function sub-mode when EngagedKey_On and CustomizationConditionEngaged_On are both equal to 1. In some embodiments, if a part of the one or more certain customization conditions is not satisfied, the processing device 110 may cause the vehicle system 100 to provide a reminder (e.g., a message push, beep, etc.) to the driver to encourage the driver to take an action so that the customization condition is satisfied.

After entering into the full-function sub-mode, the vehicle system 100 may handle all driving tasks autonomously, such as driving path planning, obstacle avoidance, speed control, stability control, etc. The vehicle 130 may drive autonomously under the control of the autonomous control unit 150 without human operations. If the vehicle system 100 receives a request from the driver for taking over the vehicle 130 during the autonomous drive of the vehicle 130, the condition value of DisengagedKey_On may be equal to 1. The processing device 110 may switch the vehicle system 100 from the full-function sub-mode to the standby sub-mode. In the standby sub-mode, the vehicle system 100 may wait for the driver to take control the vehicle 130. If no manual operation (e.g., taking control of the steering wheel, stepping on the accelerator pedal, etc.) is detected within a preset time period (e.g., 2 seconds, 5 seconds, 10 seconds, 15 seconds, etc.), the condition value of TimeOut_On may be equal to 1. The processing device 110 may switch the vehicle system 100 back to the full-function sub-mode. If there is a manual operation (e.g., stepping on the braking pedal, handling the steering wheel (e.g., with a certain torque), and/or turning on a steering lamp, etc.) is detected within the preset time period, the condition value of CustomizationConditionDisengaged_On may be equal to 1. The processing device 110 may switch the vehicle system 100 from the standby sub-mode to the starting sub-mode. The preset time period may be predetermined by the processing device 100, according to default settings of the vehicle system 100. In some embodiments, the processing device 110 may cause the vehicle system 100 to provide a reminder (e.g., a message push, beep, etc.) to the driver to take over the vehicle 130 within the preset time period.

Either in the full-function sub-mode or in the standby sub-mode, when a handleable failure (e.g., a single sensor failure, a short-term data transmission congestion, etc.) is detected in the vehicle system 100 and/or the vehicle system 100, the condition value of Handleable Error may be equal to 1. The processing device 110 may switch the vehicle system 100 from the full-function sub-mode or the standby sub-mode to the degrade sub-mode. At the same time, the vehicle system 100 may try to resolve the failure and recover the system. If the failure is resolved, the condition value of HandleableError_Clear may be equal to 1. The processing device 110 may switch the vehicle system 100 from the degrade sub-mode back to a sub-mode of the autonomous driving mode (e.g., one of the full-function sub-mode or the standby sub-mode). If the vehicle system 100 cannot handle the error, the condition value of UnHandleable_Error may be equal to 1. The processing device 110 may switch the vehicle system 100 from the autonomous driving mode (e.g., the full-function sub-mode, the standby sub-mode, or the degrade sub-mode) to the safe mode.

In the safe mode, the vehicle 130 may drive according to default instructions including that straightening the steering wheel slowly, and slowing down the vehicle 130 until the vehicle 130 stops. The processing device 110 may also generate alarm information to request the driver or a remote monitor to take over the vehicle 130 as soon as possible. If a manual operation (e.g., taking over the braking pedal, taking over the steering wheel (e.g., at a certain torque), etc.) is detected by the vehicle system 100, the condition value of DriverTakeoverAction may be equal to 1. The processing device 110 may switch the vehicle system 100 from the safe mode to the starting sub-mode to allow the driver to take a full control of the vehicle 130.

In the autonomous driving mode (e.g., the full-function sub-mode, the standby sub-mode, or the degrade sub-mode), if the road conditions are very complicated, the driver may believe that the risk of collision and other serious consequences of the autonomous drive of the vehicle 130 may increase. Under such a situation, the driver may take the initiative to take over the vehicle 130. When the vehicle system 100 detects a manual operation (e.g., taking over the braking pedal, taking over the steering wheel (e.g., at a certain torque), etc.), the condition value of DriverTakeoverAction may be equal to 1. The processing device 110 may switch the vehicle system 100 from the autonomous driving mode (e.g., the full-function sub-mode, the standby sub-mode, or the degrade sub-mode) to the starting sub-mode for the driver to take full control of the vehicle 130.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system, comprising:
at least one storage device storing a set of instructions; and
at least one processor configured to communicate with the at least one storage device, wherein when executing the set of instructions, the at least one processor is directed to perform operations including:
obtaining status information of a vehicle system, the status information including a current driving mode of the vehicle system;
obtaining at least one mode switching condition, each of the at least one mode switching condition corresponding to a candidate driving mode that triggers switching the vehicle system from the current driving mode to the candidate driving mode, wherein the current driving mode and the at least one candidate driving mode include a manual-driving mode, an autonomous driving mode, and a safe mode, and the autonomous driving mode includes at least two sub-modes;
determining that the status information of the vehicle system satisfies one of the at least one mode switching condition;
designating a candidate driving mode corresponding to the one of the at least one mode switching condition as a target driving mode; and
switching the current driving mode into the target driving mode.

2. The system of claim 1, the at least two sub-modes of the autonomous driving mode including a full-function sub-mode, a standby sub-mode, and a degrade sub-mode.

3. The system of claim 2, the at least one mode switching condition including a first mode switching condition that triggers switching the vehicle system from the full-function sub-mode to the standby sub-mode, the first mode switching condition including receipt of an instruction for manual operation.

4. The system of claim 2, the at least one mode switching condition including a second mode switching condition that triggers switching the vehicle system from the standby sub-mode to the full-function sub-mode, the second mode switching condition being that no manual operation is detected within a time period.

5. The system of claim 2, the at least one mode switching condition including a third mode switching condition that triggers switching the vehicle system from the full-function sub-mode or the standby sub-mode to the degrade sub-mode, the third mode switching condition being that the vehicle system has a correctable failure.

6. The system of claim 5, the at least one mode switching condition including a fourth mode switching condition that triggers switching the vehicle system from the degrade sub-mode to the full-function sub-mode or the standby sub-mode, the fourth mode switching condition being that the correctable failure is resolved.

7. The system of claim 1, the manual-driving mode further including a starting sub-mode and a ready sub-mode.

8. The system of claim 7, the vehicle system including a vehicle platform and an autonomous platform, the at least one mode switching condition including a fifth mode switching condition that triggers switching the vehicle system from the starting sub-mode to the ready sub-mode, the fifth mode switching condition being that failure is detected neither in the vehicle platform nor in the autonomous platform.

9. The system of claim 1, wherein the at least one processor is further directed to perform additional operations including:
obtaining, from a user, an instruction for switching the vehicle system from the current driving mode to the target driving mode;
determining that the status information of the vehicle system satisfies a mode switching condition corresponding to the target driving mode; and
switching the current driving mode to the target driving mode.

10. The system of claim 9, the instruction including at least one of operating a braking pedal of the vehicle system, operating a steering wheel of the vehicle system, pressing a mode switching button, or an oral or text instruction.

11. A method implemented on a computing device having at least one processor, at least one storage medium, and a communication platform connected to a network, the method comprising:
obtaining status information of a vehicle system, the status information including a current driving mode of the vehicle system;
obtaining at least one mode switching condition, each of the at least one mode switching condition corresponding to a candidate driving mode that triggers switching the vehicle system from the current driving mode to the candidate driving mode, wherein the current driving mode and the at least one candidate driving mode include a manual-driving mode, an autonomous driving mode, and a safe mode, and the autonomous driving mode includes at least two sub-modes;
determining that the status information of the vehicle system satisfies one of the at least one mode switching condition;
designating a candidate driving mode corresponding to the one of the at least one mode switching condition as a target driving mode; and
switching the current driving mode into the target driving mode.

12. The method of claim 11, the at least two sub-modes of the autonomous driving mode including a full-function sub-mode, a standby sub-mode, and a degrade sub-mode.

13. The method of claim 12, the at least one mode switching condition including a first mode switching condition that triggers switching the vehicle system from the full-function sub-mode to the standby sub-mode, the first mode switching condition including receipt of an instruction for manual operation.

14. The method of claim 12, the at least one mode switching condition including a second mode switching condition that triggers switching the vehicle system from the standby sub-mode to the full-function sub-mode, the second mode switching condition being that no manual operation is detected within a time period.

15. The method of claim 12, the at least one mode switching condition including a third mode switching condition that triggers switching the vehicle system from the full-function sub-mode or the standby sub-mode to the degrade sub-mode, the third mode switching condition being that the vehicle system has a correctable failure.

16. The method of claim 15, the at least one mode switching condition including a fourth mode switching condition that triggers switching the vehicle system from the degrade sub-mode to the full-function sub-mode or the standby sub-mode, the fourth mode switching condition being that the correctable failure is resolved.

17. The method of claim 11, the manual-driving mode further including a starting sub-mode and a ready sub-mode.

18. The method of claim 17, the vehicle system including a vehicle platform and an autonomous platform, the at least one mode switching condition including a fifth mode switching condition that triggers switching the vehicle system from the starting sub-mode to the ready sub-mode, the fifth mode switching condition being that failure is detected neither in the vehicle platform nor in the autonomous platform.

19. The method of claim 11, further comprising:
obtaining, from a user, an instruction for switching the vehicle system from the current driving mode to the target driving mode;
determining that the status information of the vehicle system satisfies a mode switching condition corresponding to the target driving mode; and
switching the current driving mode to the target driving mode.

20. A non-transitory computer readable medium, comprising executable instructions that, when executed by at least one processor, directs the at least one processor to perform a method, the method comprising:
obtaining status information of a vehicle system, the status information including a current driving mode of the vehicle system;
obtaining at least one mode switching condition, each of the at least one mode switching condition corresponding to a candidate driving mode that triggers switching the vehicle system from the current driving mode to the candidate driving mode, wherein the current driving mode and the at least one candidate driving mode include a manual-driving mode, an autonomous driving mode, and a safe mode, and the autonomous driving mode includes at least two sub-modes;
determining that the status information of the vehicle system satisfies one of the at least one mode switching condition;
designating a candidate driving mode corresponding to the one of the at least one mode switching condition as a target driving mode; and
switching the current driving mode into the target driving mode.
